(19) United States
(12) Patent Application Publication
(10) Pub. No.: US 2026/0246280 A1
(43) Pub. Date: Aug. 20, 2026

(54) METHOD FOR STARTING AN ELECTROLYSIS SUPPLY SYSTEM HAVING PARALLEL CONVERTERS AND REDUCED PRE-CHARGING UNIT

(71) Applicant: SMA Solar Technology AG, Niestetal (DE)

(72) Inventor: Chokri Khalfet, Kassel (DE)

(21) Appl. No.: 19/643,874

(22) Filed: Apr. 10, 2026

Related U.S. Application Data
(63) Continuation of application No. PCT/EP2024/078242, filed on Oct. 8, 2024.

(30) Foreign Application Priority Data
Oct. 12, 2023 (DE) 10 2023 127 916.5

(51) Int. Cl. H02J 3/388; C25B 15/02; H02M 1/36; H02M 7/12; H02J 101/35

(52) U.S. Cl. CPC H02J 3/388; C25B 15/02; H02M 1/36; H02M 7/125; H02J 2101/35

(57) ABSTRACT

The application relates to a method for starting an electrical supply circuit which has a first power converter, a second power converter and a rectifier circuit and is intended to supply a DC connection (DCA) with electrical energy from an AC grid, wherein at least one DC connection circuit is connected to the DC connection (DCA) and the AC grid is connected to an AC connection (ACA) of the supply circuit. The method includes pre-charging a first DC link of the first power converter and a second DC link of the second power converter via an AC pre-charging circuit from the AC grid; and forming an AC island grid through the second power converter, wherein the DC connection (DCA) is supplied with electrical energy from the AC island grid via the rectifier unit during the forming of the AC island grid.

### REFERENCE TO RELATED APPLICATIONS

This application is a Continuation of International Application number PCT/EP2024/078242, filed on October 8, 2024, which claims the benefit of German Application number 102023127 916.5, filed on October 12, 2023. The contents of the above-referenced Patent Applications are hereby incorporated by reference in their entirety.

### FIELD

The application relates to a method for starting an electrical supply circuit, to an electrical supply circuit, and to an electrolysis supply system.

### BACKGROUND

WO2023/274776A1 describes a method for starting an electrolysis system. The electrolysis system comprises an electrolyzer and a supply unit operating as a rectifier. The supply unit has an AC connection connected to an AC grid, a DC connection connected to the electrolyzer, and an AC/DC converter arranged between the AC connection and the DC connection. An output capacitor connected to a DC converter connection of the AC/DC converter is charged by operating the electrolyzer in reverse mode as a DC voltage source.

This type of charging of the DC side of an AC/DC converter requires the consumption of hydrogen, which is actually intended to be produced in an electrolysis system. Consequently, this type of charging on the DC side is disadvantageous. It is necessary to find an improved and resource-saving alternative to this approach.

Alternatively, pre-charging units are used in supply units of an electrolysis system and are used exclusively for pre-charging the electrolyzer. In this case, for example, alkaline electrolyzers, i.e., electrolysis for alkaline electrolysis (AEL), are pre-charged to their open-circuit voltage of 700 to 800 V, wherein such electrolyzers have capacitive properties of 2 to 5 F. It is common practice to gradually increase the voltage used for pre-charging the electrolyzer by the pre-charging unit, so that the pre-charging voltage rises continuously until the open-circuit voltage of the electrolyzer is reached.

Furthermore, it is economically advantageous to be able to operate an electrolyzer for as long as possible, so that discharge of the system only occurs infrequently. Since pre-charging is required only infrequently, pre-charging units are also small in size, i.e., they have a low power output rating, in order to reduce costs of the pre-charging unit. As a result of the low power output, pre-charging of the electrolyzer takes longer.

In the prior art, a pre-charging unit for an electrolyzer is provided which is used exclusively for pre-charging thereof, is used only infrequently for economic reasons, and has a low power rating. Here too, the objective is to find a cost-saving, time-saving, and high-performing alternative.

The above problem is solved by the subject matter of the disclosure.

An electrical supply circuit according to the disclosure has a first power converter, a second power converter, and a rectifier circuit. The supply circuit is intended to supply a DC connection (DC: direct current/direct voltage) with electrical energy from an AC grid (AC: alternating current/alternating voltage), wherein at least one DC connection circuit can be connected to the DC connection and the AC grid can be connected to an AC connection of the supply circuit. The DC connection circuit may, for example, be at least one DC source, at least one DC sink, and/or at least one other circuit.

A method for starting the electrical supply circuit, in which the at least one DC connection circuit is connected to the DC connection and the AC grid is connected to the AC connection of the supply circuit, involves:

pre-charging a first DC link of the first power converter and a second DC link of the second power converter via an AC pre-charging circuit from the AC grid,

forming an AC island grid via the second power converter, wherein the DC connection is supplied with electrical energy from the AC island grid via the rectifier circuit during the forming of the AC island grid.

The electrical supply circuit is configured to

pre-charge a first DC link of the first power converter and a second DC link of the second power converter via an AC pre-charging circuit from the AC grid,

form an AC island grid via the second power converter, wherein the DC connection can be supplied with electrical energy from the AC island grid via the rectifier circuit during the forming of the AC island grid.

The first and second power converters may, for example, be switched-mode inverters, which can also be operated as rectifiers. The power converters are designed in particular for the transmission of high power, e.g., in the MW range.

Pre-charging the first DC link and the second DC link serves to charge the DC links in a controlled manner in order to avoid excessive inrush currents. This improves safety and extends the service life of the components. The AC pre-charging circuit is designed, for example, to limit the current during charging of the first and second DC links. For this purpose, it may, for example, have a bypassable resistor.

The forming of the AC island grid features a continuous ramp-up of power transmission via the AC island grid, e.g., in the form of a ramp. The power converter is operated in grid-forming mode. After rectification by the rectifier circuit, this electrical power can be made available as DC power via the DC connection. The forming of forming of the island network can be used to pre-charge a DC connection circuit connected to the DC connection. The method and the supply circuit can therefore be advantageously used to pre-charge at least one DC connection circuit connected to the DC connection. The at least one DC connection circuit could, for example, be a DC sink that is to be pre-charged, such as an electrolyzer. It could also be the capacitance of at least one further circuit connected to the DC connection.

The described method and described supply circuit offer the advantage that the pre-charging circuit only needs to be provided once for the first power converter, while both power converters can be pre-charged and DC connection circuits can also be pre-charged via the DC connection. The supply circuit as a whole may be designed for the transfer of high power and may also transfer high pre-charging power via the AC island grid. However, the pre-charging circuit needs only be designed for pre-charging the first power converter and can accordingly be dimensioned to be smaller and more cost-effective. Furthermore, the DC connection circuit can be advantageously pre-charged by this method using the rated power of the power converters. This accelerates pre-charging of the DC connection circuit, since a pre-charging circuit used in the prior art is designed with low power, as described earlier. In addition, a pre-charging circuit used in the prior art for a DC connection circuit can be omitted, thus reducing costs.

The described supply circuit may have a control circuit having at least one processor, memory, and at least one input/output interface. The control circuit is configured to execute the described method, e.g., by actuating switches of the supply circuit.

In one embodiment, the first power converter, during pre-charging of the first DC link, is connected on the AC side to the AC connection and disconnected on the DC side from the DC connection. As a result, the first power converter can be pre-charged in a controlled manner via the AC pre-charging circuit.

In one embodiment, the DC side of the first power converter is connected to the DC side of the second power converter before the first DC link is pre-charged. As a result, a connection for pre-charging the second power converter via the first power converter is established - for example, by closing a switch. The second power converter can now be pre-charged in a controlled manner via the first power converter.

In one embodiment, during pre-charging of the second DC link, the second power converter is disconnected on the AC side from the AC connection and connected on the DC side to the DC side of the first power converter, wherein the DC sides of the first and second power converters are disconnected from the DC connection during pre-charging of the first and second DC links. This allows the electrical power delivered on the DC side by the first power converter to be used for DC-side pre-charging of the second power converter. Pre-charging can be controlled directly via the electrical power provided by the first power converter.

In one embodiment, after pre-charging of the second link, the AC side of the second power converter is connected to the AC side of the rectifier circuit. This connection may be established, for example, by closing a switch. The pre-charged second power converter can supply electrical power to the rectifier circuit on the AC side via this connection.

In one embodiment, during forming of the AC island grid, the AC voltage is set on the AC side of the second power converter and gradually increased. During forming of the AC island grid, the second power converter is operated in voltage-controlled mode, wherein the voltage and the electrical power transmitted via the AC island grid are slowly ramped up. During forming of the AC island grid, power transmission via the AC island grid is therefore gradually ramped up. The rectifier circuit converts the alternating voltage of the AC island grid into direct voltage. The DC voltage can be supplied via the DC connection. Since the power and voltage of the AC island grid are gradually increased, the power and voltage at the DC connection supplied via the rectifier circuit increase correspondingly.

In one embodiment, during forming of the AC island grid, the second power converter is supplied on the DC side with electrical energy by the first power converter. The first power converter can therefore be used to supply the second power converter and, for this purpose, is operated as a rectifier.

In one embodiment, during forming of the AC island grid, the at least one DC connection circuit is pre-charged via the DC connection. The forming of the AC island grid, with the associated ramping up of power, can therefore be used to pre-charge the at least one DC connection circuit connected to the DC connection. For this purpose, the AC power of the AC island grid is rectified by the rectifier circuit.

In one embodiment, after the AC island grid has been formed to supply the DC connection with electrical energy from the AC grid, the first power converter is connected on the DC side to the DC connection. The connection may be established, for example, by closing a switch. The first power converter may then be used to supply the DC connection with electrical power from the AC grid.

In one embodiment, after the AC island grid has been formed to supply the DC connection with electrical energy from the AC grid, the second power converter is connected on the DC side to the DC connection and on the AC side to the AC connection. The connections may be established, for example, by closing switches. The second power converter may then be used to supply the DC connection with electrical power from the AC grid.

In one embodiment, for supplying the DC connection with electrical energy from the AC grid, the first power converter and/or the second power converter are connected on the AC side to the AC connection and on the DC side to the DC connection. This allows for flexible supply to the DC connection, such that high power levels can also be transferred. However, for pre-charging the first and second power converters and, if applicable, at least one DC connection circuit, only a single AC pre-charging circuit needs to be provided.

In one embodiment, the rectifier circuit has a passive rectifier and/or a switched-mode AC/DC converter. The rectifier circuit may therefore be configured to be active or passive.

In one embodiment, after forming of the island network, for supplying the DC connection with electrical energy from the AC grid, the switched-mode AC/DC converter of the rectifier circuit is connected on the AC side to the AC connection and on the DC side to the DC connection. The connection may be established, for example, by closing a switch. The switched-mode AC/DC converter of the rectifier circuit can then be used to supply the DC connection with electrical power from the AC grid. This allows the transmittable electrical power to be increased further.

In one embodiment, after forming of the island network, at least one DC connection circuit and/or at least one further DC connection circuit is supplied with electrical energy from the AC grid via the DC connection, wherein the supply of electrical energy is effected via the first power converter, the second power converter, and/or the switched-mode AC/DC converter. This further increases the flexibility of the supply to the DC connection and enables even higher power to be transferred.

In one embodiment, after the forming of the AC island grid, for supplying the DC connection with electrical energy from the AC grid, the at least one DC connection circuit of the electrical supply circuit is connected in parallel. If, for example, the at least one DC connection circuit is a further circuit that includes power converters without a pre-charging circuit, the capacitances, e.g., DC links of the power converters of the further circuit, may have been pre-charged via the supply circuit. The power converters of the further circuit can then be connected in parallel to the supply circuit and likewise transfer power from the AC grid to the DC connection and supply the DC connection circuits connected there with electrical energy.

In one embodiment of the supply circuit, the at least one DC connection circuit is configured as an electrolyzer which can be pre-charged via the DC connection during forming of the AC island grid. This offers the advantage that an electrolyzer, which requires pre-charging and is to be supplied with high power during operation after pre-charging, can be supplied by the described supply circuit that was started according to the described method. In this case, only one AC pre-charging circuit is required in the supply circuit, which may be designed for high power.

In one embodiment, electrical energy can be fed via the electrical supply circuit from the DC connection into the AC grid that can be connected to the AC connection. The supply circuit is designed such that electrical power can be transferred in both directions. This is advantageous, for example, in a DC connection circuit having a DC source. The DC source may, for example, be a photovoltaic generator, a fuel cell, or the like.

An electrolysis supply system according to the disclosure has the described electrical supply circuit and optionally a transformer. The electrolysis supply system serves to supply an electrolysis system having one or more electrolyzers with electrical energy from the AC grid, e.g., an AC supply network.

### BRIEF DESCRIPTION OF THE FIGURES

The following section provides further explanation and description of example embodiments of this application with reference to the figures, in which:

FIG. 1 schematically shows a first embodiment of an electrical supply circuit,

FIG. 2 schematically shows a second embodiment of an electrical supply circuit,

FIG. 3 schematically shows a third embodiment of an electrical supply circuit,

FIG. 4 schematically shows a method for starting the electrical supply circuit,

FIG. 5 schematically shows a fourth embodiment of an electrical supply circuit,

FIG. 6 schematically shows an electrical supply circuit with another circuit and

The same reference signs are used in the figures for identical or similar elements. Representations in the figures may not be to scale.

### DETAILED DESCRIPTION

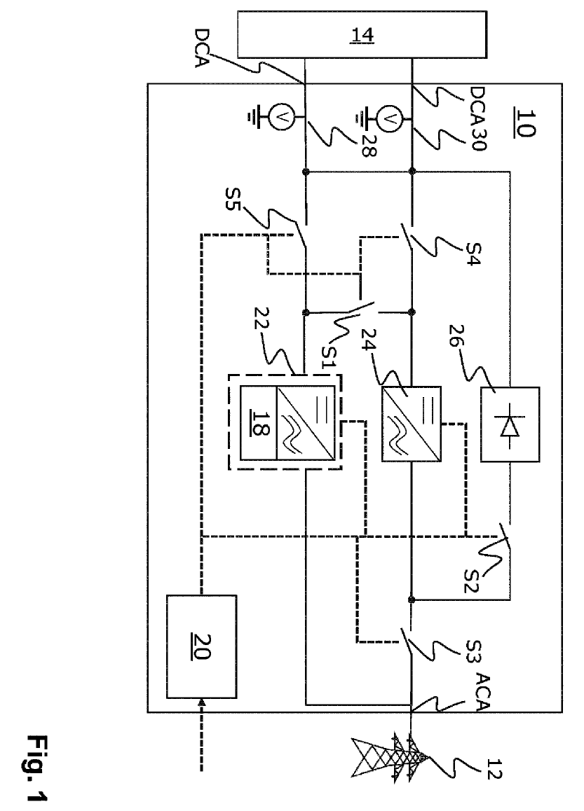

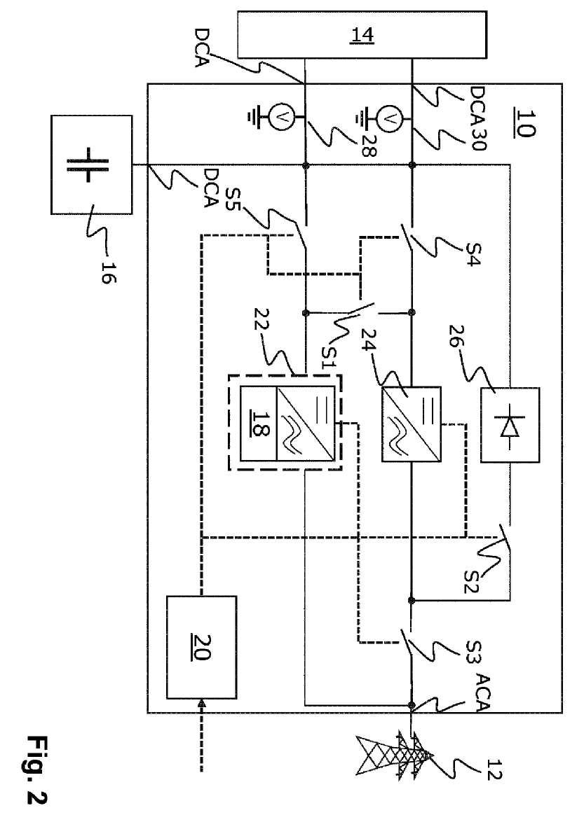

FIG. 1 schematically shows a first embodiment of an electrical supply circuit 10. An AC grid 12, e.g., an AC supply network illustrated by a high-voltage pylon merely by way of example, is connected to an AC connection ACA of the supply circuit 10, wherein this constitutes no limitation to a specific voltage range of the AC grid, and the AC grid 12 may also be a medium-voltage or low-voltage network. The AC grid may, for example, be a three-phase, single-phase, or two-phase AC grid. A DC connection circuit, e.g., a DC sink 14, is connected to a DC connection DCA of the supply circuit 10. The DC sink 14 may, for example, have a DC load such as an electrolyzer or DC motor or the like.

The supply circuit 10 has a first power converter 22 and a second power converter 24. The first and second power converters 22, 24 are configured, in one embodiment, as inverters having a switched-mode bridge circuit, which can also be operated as rectifiers. The supply circuit 10 also has a rectifier circuit 26. In the example embodiment shown in FIG. 1, the rectifier circuit 26 has a passive rectifier circuit, e.g., a diode.

A first DC link of the first power converter 22 and a second DC link of the second power converter 24 can be pre-charged from the AC grid 12 via an AC pre-charging circuit 18, which can be integrated into the first power converter 22 (indicated by a dashed line). During pre-charging of the first DC link and the second DC link, a capacitor, which may alternatively comprise several capacitors, of the first DC link is charged. In this process, electrical power is transferred in a controlled manner from the AC grid 12 to the capacitor via the AC pre-charging circuit 18. In one embodiment, current spikes that could otherwise occur when voltage is applied to the capacitor are avoided during pre-charging. During pre-charging of the first power converter 22 and the second power converter 24, the switches S2, S3, S4, and S5 of the supply circuit 10 are open. Pre-charging via the AC pre-charging circuit can be controlled, for example, via the control circuit 20.

Once pre-charging of the first link of the first power converter 22 and the second link of the second power converter 24 is complete, or during pre-charging of the second DC link, a capacitor, which may alternatively comprise several capacitors, of the second DC link is charged. In this process, electrical power from the AC grid 12 is transferred in a controlled manner to the capacitor via the AC pre-charging circuit 18 of the first power converter 22. Pre-charging can be controlled, for example, via control circuit 20.

Once pre-charging of the second link of the second power converter 24 is complete, the second power converter 24 can be connected on the AC side to the rectifier circuit 26 by closing the switch S2. The second power converter 24 now forms an AC island grid on its AC side. The AC island grid is synchronized with the power supply grid. During forming of the AC island grid, the second power converter 24 is supplied on the DC side with electrical power by the first power converter. The first power converter 22 draws electrical power from the AC grid and acts as a rectifier circuit. The second power converter 24 is operated as an inverter and is operated in voltage control mode on the AC side, wherein the AC voltage is gradually ramped up to form the AC island grid. The AC voltage of the AC island grid is rectified by the rectifier circuit 26 and made available via the DC connection DCA. The DC connection DCA may have one or more connection points at which respective voltage meters 28, 30 can be arranged.

By gradually ramping up the voltage of the AC island grid, it is possible to operate DC connection circuits, e.g., at least one DC sink 14, at the DC connection, which units should also be pre-charged and/or ramped up - for example, with a gradually increasing voltage. This is advantageous in one embodiment when connecting a DC sink 14 which has one or more electrolyzers. The DC sink 14 with electrolyzer can thus be gradually pre-charged and/or ramped up by the supply circuit 10.

If no further power is transferred to the DC connection DCA via the AC island grid, the pre-charging process is complete, and the supply cicuit 10 can transition to an operating mode in which it transfers electrical power between the AC connection ACA and the DC connection DCA.

For this purpose, the first and second power converters 22, 24 can each be connected to the DC connection DCA on the DC side by opening switch S1 and closing switches S4 and S5. When switch S2 is opened, the rectifier circuit 26 can be disconnected from the second power converter 24 on the AC side. When switch S3 is closed, the second power converter 24 can be connected to the AC connection ACA on the AC side. The first and second power converters 22, 24 can now each be operated as rectifiers and used to supply the DC sink 14 with electrical power from the AC grid 12. Typical rated powers of the first and/or the second power converters 22, 24 may range between 2 and 10 MW, e.g., 6 MW.

When used for three-phase AC grids, the first and second power converters may, for example, be configured as three-phase inverters, and the rectifier circuit may, for example, be configured as an uncontrolled three-phase bridge B6U.

The switches S1, S2, S3, S4, S5 of the supply circuit 10 from FIG. 1 can be controlled by the control circuit 20. The first and second power converters 22, 24 can likewise be controlled by the control circuit 20 and/or by further control circuits, which may each be arranged, for example, in the corresponding power converters 22, 24.

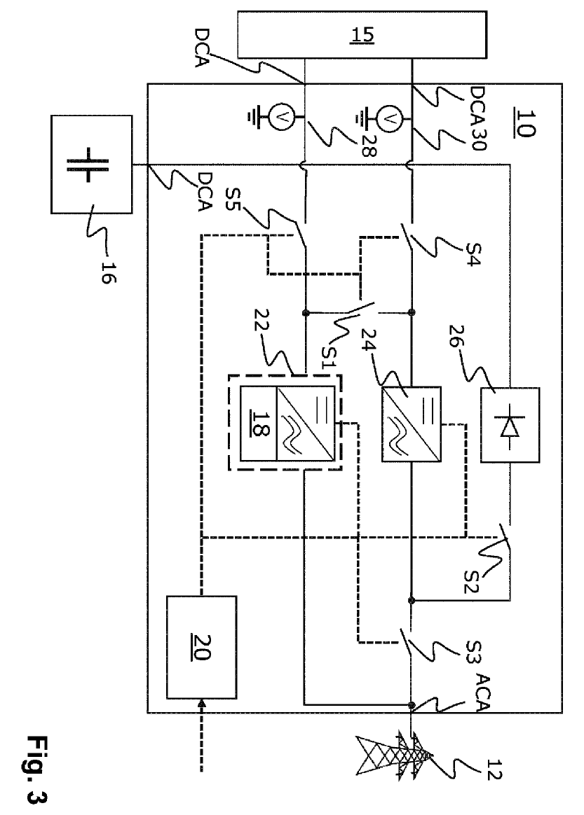

FIG. 2 schematically shows a second embodiment of the electrical supply circuit 10. The DC connection DCA of the supply circuit 10 has an additional connection point in FIG. 2 compared to FIG. 1.

A further DC connection circuit, configured as a further circuit 16, is connected at the additional connection point. The further circuit 16 may also, for example, have a capacitor that can be pre-charged via the DC connection DCA. The further circuit 16 may also, for example, be one or more power converters, electrolyzers, or fuel cells, whose capacitors of the respective DC links can be pre-charged via the DC connection DCA.

Pre-charging of the DC connection circuits 14, 16 connected to the DC connection is carried out here, as described in relation to FIG. 1, during the phase of forming the AC island grid through the second power converter 24.

Pre-charging of the first and second power converters 22, 24 can be carried out as described in relation to the first example embodiment of FIG. 1.

After pre-charging the DC connection circuits - in the illustrated example, DC sink and further circuit 16 - the DC sink, as described with reference to FIG. 1, can be supplied with electrical power from the AC grid 12 via the first and second power converters 22, 24 of the supply circuit 10.

In this example embodiment as well, when used for three-phase AC grids, the first and second power converters may be configured, for example, as three-phase inverters, and the rectifier circuit may be configured, for example, as an uncontrolled three-phase bridge B6U. The switches S1, S2, S3, S4, S5 of the supply circuit 10 from FIG. 2 can likewise be controlled by the control circuit 20. The first and second power converters 22, 24 can likewise be controlled by the control circuit and/or by further control circuits, which may each be arranged, for example, in the corresponding power converters 22, 24.

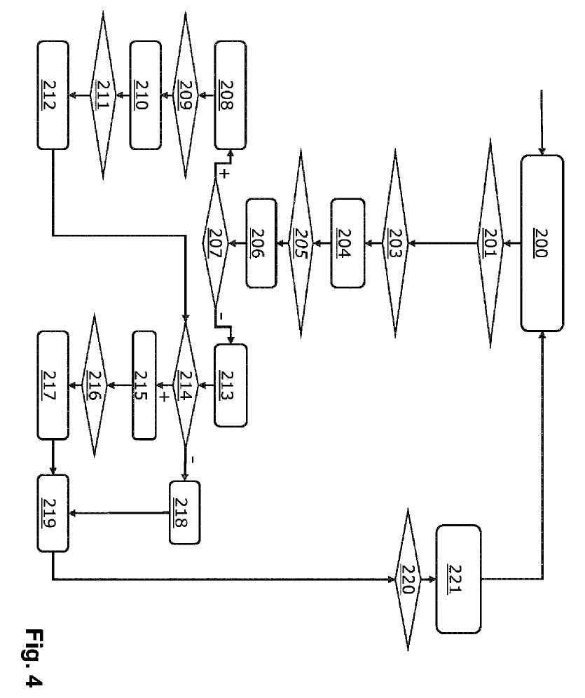

FIG. 3 schematically shows a third embodiment of the electrical supply circuit 10. The further circuit 16 is connected to a connection point of the DC connection DCA, as in the example embodiment shown in FIG. 2. The further DC circuit 16 can, as described, be, for example, one or more power converters whose capacitors of the respective DC links can be pre-charged via the DC connection DCA.

Pre-charging of the first and second power converters 22, 24 can be carried out as described with reference to the first or second example embodiment of FIG. 1 or FIG. 2.

In this example embodiment, during the phase of forming the AC island grid through the second power converter 24, pre-charging of the further circuit takes place. At the other connection points 15, at least one DC source, e.g., a photovoltaic generator, is connected. During the forming phase of the AC island grid, the supply circuit 10 can be used to pre-charge the further circuit 16. If the DC source requires pre-charging, it can also be pre-charged via the DC connection DCA.

If no further power is transferred to the DC connection DCA via the AC island grid, the pre-charging processes are complete and the supply circuit 10 can transition to an operating mode in which it transfers electrical power between the AC connection ACA and the DC connection DCA.

For this purpose, the first and second power converters 22, 24 can each be connected to the DC connection DCA on the DC side by opening switch S1 and closing switches S4 and S5. When switch S2 is opened, the rectifier circuit 26 can be disconnected from the second power converter 24 on the AC side. When switch S3 is closed, the second power converter 24 can be connected to the AC connection ACA on the AC side. The first and second power converters 22, 24 can now each be operated as inverters, and the DC source can feed electrical power into the AC grid 12 via the first and second power converters 22, 24 of the supply circuit 10.

In this example embodiment as well, the first and second power converters may be configured for use with AC grids and may, for example, have uncontrolled three-phase bridges B6U. The switches S1, S2, S3, S4, S5 of the supply circuit 10 from FIG. 3 can also be controlled by the control circuit 20. The first and second power converters 22, 24 can likewise be controlled by the control circuit 20 and/or by further control circuits, which may each be arranged, for example, in the corresponding power converters 22, 24.

There may also be DC connection circuits that can behave both as a DC sink 14 and as a DC source 15. Examples include rechargeable batteries, which act as a DC sink 14 when they are charged and as a DC source 15 when they are discharged, i.e., when supplying DC power.

It is also possible that one or more DC sinks 14, one or more DC sources 15, and/or one or more further circuits 16 may be connected to the DC connection DCA. In such cases, the supply unit can pre-charge the respective AC connection units via the forming of the AC island grid. Depending upon the operating mode, electrical energy can subsequently be fed into the AC grid 12 via the supply circuit 10, or the DC connection DCA can be supplied with electrical power from the AC grid via the supply circuit 10. Switching between the operating modes is possible. Switching between operating modes can be performed, for example, by the control circuit 20.

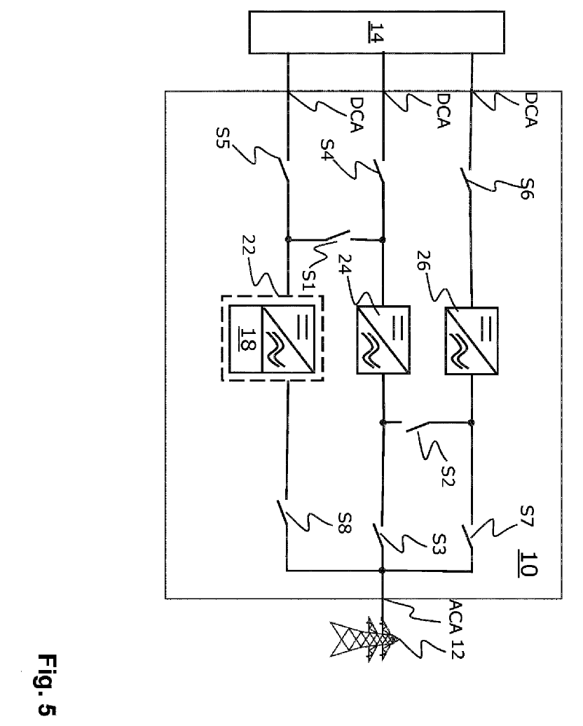

FIG. 4 schematically shows a method for starting the electrical supply circuit 10.

When the method starts at 200, switches S2, S3, S4, S5 are open. Switch S1 is closed.

At 201, pre-charging of the first and second power converters 22 and 24 is started via the AC pre-charging circuit 18 if the DC-side output voltage of the first power converter 22 is zero, i.e., the first and second DC links are discharged. After pre-charging is complete, the DC-side output voltage of the first power converter 22 and of the second power converter 24 corresponds to the DC voltage of the first DC link.

At 203, pre-charging of the first and second power converters 22, 24 is terminated when the DC voltage of the second rectifier 24 corresponds to the rated voltage.

At 204, after termination of pre-charging at 203, switch S2 is closed and the second power converter 24 begins, in operation as an inverter, to form the AC island grid on its AC side. During forming of the island network, electrical power can be transferred via the rectifier circuit 26 to the DC connection. This electrical power can be used to pre-charge DC connection units connected to the DC connection.

Act 205 checks whether the power transfer via the AC island grid and the rectifier unit 26 to the DC connection DCA has been completed.

If so, switch S2 is opened at 206.

Act 207 checks whether the second power converter 24 is required for power transfer via the supply circuit 10.

If the result of the check at 207 is “yes,” then, at 208, switch S1 is opened and the second power converter 24 is synchronized on the DC side with the voltage measured by the voltmeter 30.

Act 209 checks whether the DC voltage at the second power converter 24 corresponds to the voltage measured by the voltmeter 30.

If so, at 210, switch S4 is closed and the second power converter 24 is stopped.

Act 211 checks whether the second power converter 24 has been stopped.

If so, in step 212, switch S3 is closed and the second power converter 24 is started in the desired power converter mode.

If the result of the check at 207 is “no,” then, at 213, the second power converter 24 is stopped and switch S1 is opened.

After act 212 or 213, act 214 checks whether the first power converter 22 is required for power transfer via the supply circuit 10.

If the result of the check at 214 is “yes,” then, at 215, the first power converter 22 is synchronized on the DC side with the voltage measured by the voltmeter 28.

Act 216 checks whether the DC voltage at the first power converter 22 corresponds to the voltage measured by the voltmeter 28.

If so, at 217, switch S5 is closed and the first power converter 22 is started in the desired power converter mode.

If the result of the check at 216 is "no," then, at 218, the first power converter 22 is stopped.

At 219, the supply circuit 10 is operated for electrical power transfer between DC connection DCA and AC connection ACA.

Act 220 checks whether a command to stop the supply circuit 10 is present.

If so, at 221, the first power converter 22 and the second power converter 24 are stopped.

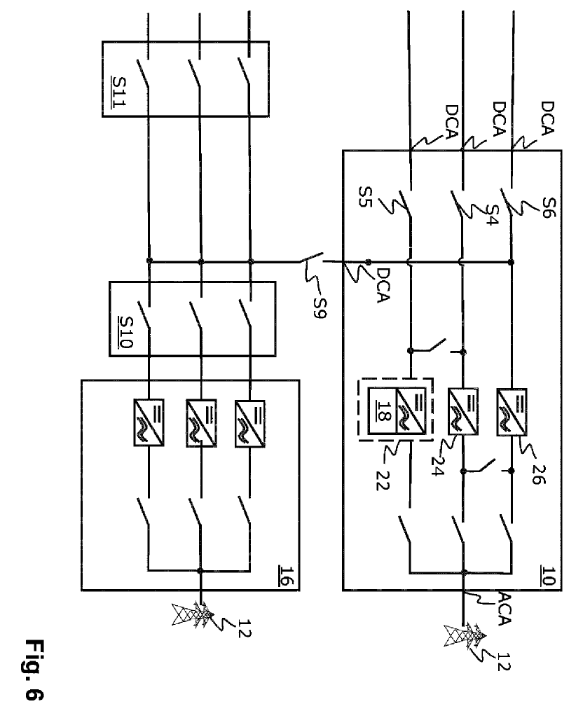

FIG. 5 schematically shows a fourth embodiment of an electrical supply circuit 10. At least one DC sink 14, e.g., at least one electrolyzer, is connected to the DC connection DCA. In this embodiment, the rectifier circuit 26 has an active rectifier having a switched-mode bridge circuit. In this embodiment, the rectifier circuit 26 may optionally also be operated as an inverter.

Pre-charging of the first and second power converters 22, 24 can be carried out as described with reference to the first, second, or third exemplary embodiment of FIG. 1, FIG. 2, or FIG. 3 or according to the method as described with reference to FIG. 4.

During the phase in which the AC island grid formed by the second power converter 24 pre-charges the DC sink 14 connected to the DC connection DCA, the switched-mode rectifier of the rectifier circuit 26 operates as a rectifier that rectifies the electrical AC power for the DC connection DCA.

If no further power is then transferred to the DC connection DCA via the AC island grid, the pre-charging processes are complete, and the supply circuit 10 can transition into an operating mode in which it transfers electrical power between the AC connection ACA and the DC connection DCA. In the fourth example embodiment shown, this power transfer may optionally be carried out via the switched-mode rectifier of the rectifier circuit 26 in addition to the first and second power converters 22, 24.

For this purpose, the first and second power converters 22, 24 and the rectifier circuit 26 can each be connected on the DC side to the DC connection DCA by opening switch S1 and by closing switches S4, S5, S6. When switch S2 is opened, the rectifier circuit 26 can be disconnected from the second power converter 24 on the AC side. When switch S8 is closed, the first power converter 22 can be connected on the AC side to the AC connection ACA. When switch S3 is closed, the second power converter 24 can be connected to the AC connection ACA on the AC side. When switch S7 is closed, rectifier circuit 26 can be connected on the AC side to the AC connection ACA. The first and second power converters 22, 24 and the rectifier circuit 26 can now each be operated as rectifiers, and the DC sink can be supplied with electrical power from the AC grid 12 via the first and second power converters 22, 24 and the rectifier circuit 26 of the supply circuit 10. The supply circuit 10 can flexibly use the first power converter 22, the second power converter 24, and/or the rectifier circuit 26 for power transfer.

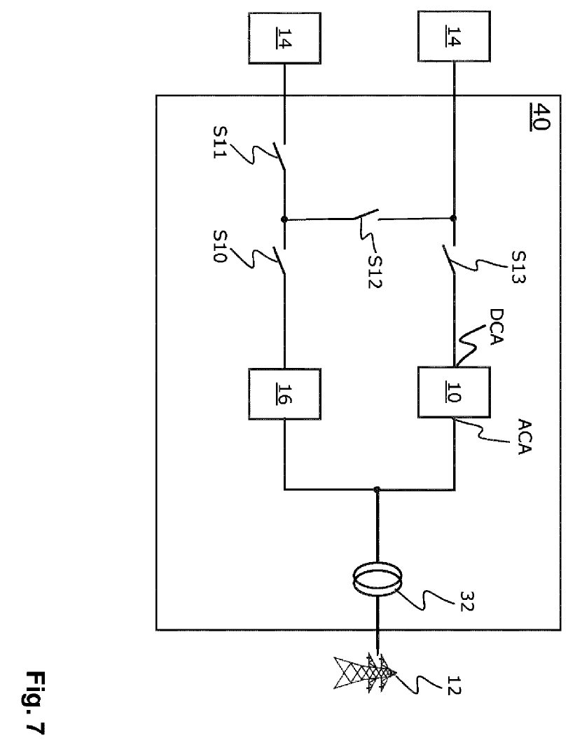

FIG. 6 schematically shows an electrical supply circuit 10 with a further circuit 16. The illustrated supply circuit 10 is similar to the one shown in FIG. 5.

The further circuit 16 is connected to a further connection point of the DC connection DCA. In this example, the further circuit 16 is configured for power transfer between an AC side and a DC side. For this purpose, the further circuit 16 has three electrical power converters having switched-mode bridge circuits, which are provided for this power transfer. These power converters each have DC links which can be pre-charged via the AC island grid of the supply circuit.

Therefore, if switches S6, S4, S5, as well as S9 and S10 are closed, a DC sink 14 at the DC connection DCA and/or the DC links of the further circuit 16 can be pre-charged. If switch S11 is closed, a further DC sink 14 connected thereto can also be pre-charged via the AC island grid formed by the second inverter 24 of the supply circuit 10.

FIG. 7 schematically shows an electrolysis supply system 40. The electrolysis supply system 40 has one of the described supply circuits 10, the further circuit 16, and a transformer 32. The electrical supply circuit 10 is connected to the AC grid 12 via its AC connection and a transformer 32. For example, the AC grid 12 is a three-phase AC supply network.

The electrolysis supply system 40 is configured to supply one or more DC sinks 14, e.g., electrolyzers.

The supply circuit 10 can be started as described, wherein, by closing switches S10, S11, S12, and S13, the further circuit 16 and the DC sinks 14 can be pre-charged via the DC connection DCA of the supply circuit 10 as the AC island grid is formed by the supply circuit 10. After pre-charging, both the supply circuit 10 and the further circuit 16 can then supply the DC sinks 14 with electrical DC power from the AC grid. For this purpose, switches S13, S10, and S11 are then closed, and switch S12 is open.

The electrolysis supply system 40 described above can transmit electrical power in the MW range. At the same time, it is sufficient, for pre-charging the supply circuit 10 and the DC sinks 14, to provide the single AC pre-charging circuit 18 described. This enables a cost-effective solution, since it is sufficient to configure the AC pre-charging circuit 18, with regard to the dimensions of its components, for the first and second power converters 22 and 24.

What is claimed is:

1. A method for starting an electrical supply circuit which has a first power converter, a second power converter, and a rectifier circuit and is intended to supply a DC connection with electrical energy from an AC grid, wherein at least one DC connection circuit is connected to the DC connection and the AC grid is connected to an AC connection of the supply circuit, the method comprising:
pre-charging a first DC link of the first power converter and a second DC link of the second power converter via an AC pre-charging circuit from the AC grid,
forming an AC island grid through the second power converter, wherein the DC connection is supplied with electrical energy from the AC island grid via the rectifier circuit during the forming of the AC island grid.

2. The method according to claim 1, wherein a DC side of the first power converter is connected to the DC side of the second power converter before pre-charging the first DC link.

3. The method according to claim 1, wherein an AC side of the second power converter is connected to the AC side of the rectifier circuit after pre-charging the second DC link.

4. The method according to claim 1, wherein, during forming of the AC island grid, an AC voltage is set and gradually increased by the second power converter on its AC side.

5. The method according to claim 1, wherein the second power converter is supplied on the DC side with electrical energy by the first power converter during the forming of the AC island grid.

6. The method according to claim 1, wherein, during the forming of the AC island grid, the DC connection unit is pre-charged via the DC connection.

7. The method according to claim 1, wherein, after the forming of the AC island grid, to supply the DC connection with electrical energy from the AC grid, the first power converter is connected to the DC connection on the DC side.

8. The method according to claim 1, wherein, after the forming of the AC island grid, to supply the DC connection with electrical energy from the AC grid, the second power converter is connected to the DC connection on a DC side and to the AC connection on an AC side.

9. The method according to claim 1, wherein the rectifier circuit comprises a passive rectifier circuit and/or a switched-mode AC/DC converter.

10. The method according to claim 9, wherein, after forming the AC island grid, to supply the DC connection with electrical energy from the AC grid, the switched-mode AC/DC converter of the rectifier circuit is connected on the AC side to the AC connection and on the DC side to the DC connection.

11. The method according to claim 9, wherein, after the forming of the AC island grid, the DC connection circuit and/or at least one further DC connection circuit is supplied with electrical energy from the AC grid via the DC connection, wherein a supply of electrical energy is effected via the first power converter, the second power converter, and/or the switched-mode AC/DC converter.

12. The method according to claim 1, wherein the at least one DC connection circuit is configured as an electrolyzer which is pre-charged via the DC connection during the forming of the AC island grid.

13. The method according to claim 1, wherein, after the forming of the AC island grid, for supplying the DC connection with electrical energy from the AC grid, the at least one DC connection circuit of the electrical supply circuit is connected in parallel.

14. An electrical supply circuit having a first power converter, a second power converter, and a rectifier circuit and configured to supply a DC connection with electrical energy from an AC grid, wherein at least one DC connection circuit is connected to the DC connection and the AC grid is configured to be connected to an AC connection of the supply circuit, wherein the supply circuit is configured to:
pre-charge a first DC link of the first power converter and a second DC link of the second power converter via an AC pre-charging circuit from the AC grid,
form an AC island grid through the second power converter, wherein the DC connection is supplied with electrical energy from the AC island grid via the rectifier circuit during the forming of the AC island grid.

15. The electrical supply circuit according to claim 14, wherein the first power converter is connected on the AC side to the AC connection and is disconnected on the DC side from the DC connection during pre-charging of the first DC link and the second DC link.

16. The electrical supply circuit according to claim 14, wherein the second power converter is disconnected on the AC side from the AC connection during pre-charging of the first DC link and the second DC link, and is connected on the DC side to the DC side of the first power converter, wherein the DC side of the first and second power converters is disconnected from the DC connection during pre-charging of the first DC link and the second DC link.

17. The electrical supply circuit according to claim 14, wherein, for supplying the DC connection with electrical energy from the AC grid, the first power converter and/or the second power converter are connected on the AC side to the AC connection and on the DC side to the DC connection.

18. The electrical supply circuit according to claim 14, wherein the rectifier circuit has a passive rectifier circuit and/or a switched-mode AC/DC converter.

19. The electrical supply circuit according to claim 14, wherein the at least one DC connection circuit is configured as an electrolyzer which can be pre-charged via the DC connection during the forming of the AC island grid.

20. The electrical supply circuit according to claim 14, wherein, via the electrical supply circuit, electrical energy is fed from the DC connection into the AC grid that is connected to the AC connection.

21. An electrolysis supply system having an electrical supply circuit that comprises:
a first power converter,
a second power converter, and
a rectifier circuit, and configured to supply a DC connection with electrical energy from an AC grid, wherein at least one DC connection circuit is connected to the DC connection and the AC grid is configured to be connected to an AC connection of the supply circuit, wherein the supply circuit is configured to:
pre-charge a first DC link of the first power converter and a second DC link of the second power converter via an AC pre-charging circuit from the AC grid,
form an AC island grid through the second power converter, wherein the DC connection is supplied with electrical energy from the AC island grid via the rectifier circuit during the forming of the AC island grid.
